(19) United States
(12) Patent Application Publication
(10) Pub. No.: US 2024/0159372 A1
(43) Pub. Date: May 16, 2024

(54) Lighting Device for a Motor Vehicle

(71) Applicant: Bayerische Motoren Werke Aktiengesellschaft, Muenchen (DE)

(72) Inventors: Sebastien CASENAVE, Muenchen (DE); Andreas LANG, Groebenzell (DE); Martin RIEDNER, Muenchen (DE)

(21) Appl. No.: 18/280,710

(22) PCT Filed: May 4, 2022
(86) PCT No.: PCT/EP2022/061888

§ 371 Date: Sep. 7, 2023

(30) Foreign Application Priority Data
May 21, 2021 (DE) 10 2021 113 216.9

(51) Int. Cl. F21S 41/65; F21S 41/20; F21S 41/24; F21S 45/10; F21W 102/13; F21W 103/55

(52) U.S. Cl. CPC F21S 41/65; F21S 41/24; F21S 41/28; F21S 45/10; F21W 2102/13; F21W 2103/55

(57) ABSTRACT

A lighting device for a motor vehicle includes one or more first lighting units, each of which is configured to generate a light distribution for a dipped beam function and/or a high beam function, and one or more second lighting units, each of which is configured to generate a light distribution for another lighting function. The first lighting unit(s) and the second lighting unit(s) are all covered by a common outer light panel which is translucent at least in some sections and via which light originating from the first lighting unit(s) and from the second lighting unit(s) exits from the lighting device. Each of the first lighting unit(s) is arranged at a distance from the outer light panel. Each of the second lighting unit(s) is rigidly connected to the outer light panel or is arranged at a distance from the outer light panel.

### BACKGROUND AND SUMMARY OF THE INVENTION

The invention relates to a lighting device for a motor vehicle.

The prior art discloses integrating, in a front headlamp of a motor vehicle, further light functions as well as the main light functions (e.g. dip beam and high beam), for example daytime running light, position light or turn signal. The lighting units with the corresponding light functions are generally positioned behind a transparent outer lens, through which the light for the light functions exits from the headlamp.

Especially in the case of a construction in which the outer lens concludes flush with the bumper fascia of the motor vehicle, in the event of a low-speed impact, there should be prevention of movement of or damage to the lighting units within the lighting device as a result of the deformation or movement of the outer lens caused thereby.

It is an object of the invention to create a lighting device for a motor vehicle in which the risk of damage to the lighting units installed therein is minimized in the event of a low-speed impact.

This object is achieved by the lighting device according to the claimed invention.

The lighting device of exemplary embodiments of the invention is intended for a motor vehicle, for example a car and possibly even a truck. Where interactions between the lighting device and components of the motor vehicle are described hereinafter, and especially in the claims, this should always be understood such that the interaction occurs in the case of arrangement or installation of the lighting device in the motor vehicle. The components of the lighting device that interact correspondingly with the motor vehicle or components of the motor vehicle are thus configured such that the interaction is caused in the case of arrangement or installation of the lighting device in the motor vehicle.

The lighting device according to exemplary embodiments of the invention comprises one or more first lighting units that are each set up to create a light distribution for a dip beam function and/or a high beam function. In one variant, only a single first lighting unit is installed in the lighting device, but it is also possible that there are two or more such lighting units for implementation of the dip beam function or high beam function. The first lighting unit (if only one is present) is, or the totality of all first lighting units are, set up to create both a dip beam function and a high beam function. The dip beam function or main beam function means that the lighting device of exemplary embodiments of the invention constitutes a lighting device for the front of the corresponding motor vehicle.

As well as the first lighting unit(s), the lighting device of exemplary embodiments of the invention includes one or more second lighting units that are each set up to create a light distribution for a light function other than the dip beam function and the main beam function. Preferably, at least some of the second lighting units and possibly even all second lighting units are set up to create a light distribution for a signal light function.

The first lighting unit or the first lighting units and the second lighting unit or the second lighting units in the lighting device of exemplary embodiments of the invention are covered by a common outer lens which is transparent at least in sections and through which light coming from the first lighting unit or the first lighting units and the second lighting unit or the second lighting units exits from the lighting device. Here and hereinafter, the term “light” refers to optical radiation in a wavelength range visible to the human eye. Moreover, here and hereinafter, the term “transparent” is understood to mean that there is a transmittance of greater than zero and especially of 50% or more and preferably of 90% or more for light.

In the lighting device of exemplary embodiments of the invention, the first lighting unit or the first lighting units are each spaced apart from the outer lens. In addition, the second lighting unit or the second lighting units are each (mechanically) rigidly connected to the outer lens or spaced apart from the outer lens. It may be possible here for some of the second lighting units each to be rigidly connected to the outer lens, while some other second lighting units are each spaced apart from the outer lens. Preferably, at least some of the second lighting units are rigidly connected to the outer lens, and it is optionally also possible for all these second lighting units to be both rigidly and directly (i.e. without further bridging components) connected to the outer lens. The rigid (mechanical) connection may be different depending on the configuration. In particular, this may be a cohesive and/or force-fitting and/or form-fitting connection.

The lighting device of exemplary embodiments of the invention has the advantage that damage to the first lighting unit(s) in the event of a low-speed impact (e.g. a minor parking accident) is avoided because they are spaced apart from the outer lens. By contrast, damage to the second lighting unit(s) in the event of such an impact is counteracted in that, because of the rigid connection to the outer lens, they move therewith, or in that they are spaced apart from the outer lens. The rigid connection of the second lighting units to the outer lens also achieves a compact construction of the lighting device.

In a particularly preferred variant of the lighting device of the invention, the second lighting unit or the second lighting units are set up to create a light distribution for a daytime running light and/or for a position light and/or for a turn signal and/or for illumination of an area along the outer lens and/or for contour lighting along one edge of the outer lens. The area lighting may be used, for example, in a lighting effect in order to generate a pleasing dynamic distribution of light, for example as welcome light when the motor vehicle is unlocked.

In a further configuration of the lighting device of the invention, at least a first lighting unit and preferably each first lighting unit is a lighting module comprising a housing in which there is disposed a light emitter for creation of the light distribution for the dip beam function and/or the high beam function. The light emitter may comprise, for example, one or more LEDs and/or laser diodes.

In a further preferred variant of the invention, the housing of the first lighting unit configured as lighting module is connected to the outer lens via a flexible connector. The flexible connector is preferably a sleeve with two opposite open ends, with one end of the sleeve secured to the housing of the lighting module, preferably around a light exit opening, and the other end of the sleeve secured to the outer lens.

In order to prevent the penetration of soil or other particles into the first lighting unit configured as lighting module, the sleeve, in a preferred embodiment, is formed from material impervious to dust and is secured with sealing by its ends to the housing of the first lighting unit and to the outer lens.

In a further preferred embodiment, at least one second lighting unit and preferably each second lighting unit is a lighting module comprising a housing in which there is disposed a light emitter for creating the light distribution for the light function other than the dip beam function and high beam function. The light emitter may comprise, for example, one or more LEDs and/or laser diodes.

In a particularly preferred embodiment, the housing of the second lighting unit configured as a lighting module is (mechanically) rigidly and preferably directly (i.e. without bridging components) connected to the outer lens, which ensures simple assembly of the lighting device. The rigid (mechanical) connection may be different depending on the configuration. In particular, this may be a cohesive and/or force-fitting and/or form-fitting connection.

In a further configuration, at least one second lighting unit comprises a surface light guide. Depending on the configuration, the surface light guide may be rigidly connected to the outer lens or else optionally be spaced apart therefrom.

In a further preferred configuration, the lighting device of the invention, as well as the first and second lighting units, also comprises one or more radiation units for emission of radiation other than light, for example in the form of one or more radar devices and/or lidar devices. This variant allows functional units that do not have a lighting function but assume other functions (especially distance measurement) to be integrated into the lighting device of exemplary embodiments of the invention.

In a preferred variant of the embodiment just described, at least one radiation unit and optionally each radiation unit is connected rigidly and preferably directly (i.e. without bridging components) to the outer lens, which ensures a compact construction of the lighting device. The rigid (mechanical) connection may be different according to the configuration. In particular, this may be a cohesive and/or force-fitting and/or form-fitting connection.

In a further preferred embodiment, the outer lens of the lighting device is formed from plastic, which may comprise polyurethane for example. This reduces the weight of the outer lens. The plastic is preferably a multicomponent injection molding, which is easy to produce. In addition, by way of a multicomponent injection molding, it is possible to form transparent and opaque regions in the outer lens in a simple manner.

In a further preferred variant, an inner surface of the lighting device which is visible through the outer lens has an absorptivity of 50% or more, especially of 90% or more, for light. In other words, the visible inner region of the outer lens is configured to look dark, which achieves a pleasing cold appearance of the lighting device in the form of a continuous dark area.

In a further preferred embodiment, the outer lens of the lighting device of the invention, on installation in the motor vehicle, has an extent in transverse direction of the motor vehicle that extends from one edge of the motor vehicle to essentially the center thereof. This achieves a pleasing design in which the configuration of a kidney on the front of the motor vehicle is dispensed with entirely.

As well as the lighting device of exemplary embodiments of the invention, the invention relates to a motor vehicle comprising one or more of the lighting devices of exemplary embodiments of the invention.

A working example of the invention is described in detail hereinafter with reference to the appended figures.

### BRIEF DESCRIPTION OF THE DRAWINGS

FIG. 1 shows a schematic diagram of one embodiment of a lighting device of the invention in a top view of the outer lens thereof.

FIG. 2 shows a section view along line L1 in FIG. 1.

FIG. 3 shows a section view along line L2 in FIG. 1.

FIG. 4 shows a section view along line L3 in FIG. 1.

FIG. 5 shows a detail view of a section from FIG. 4.

### DETAILED DESCRIPTION OF THE DRAWINGS

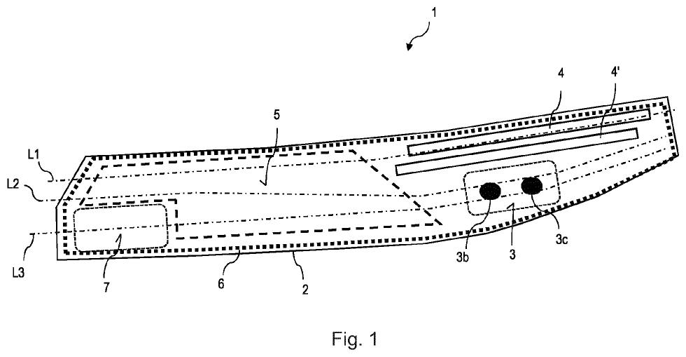

There follows a description of an embodiment of the invention with reference to a motor vehicle lighting device in the form of a left-hand front headlamp. This headlamp is shown schematically in FIG. 1 in a top view from the front onto the front of the motor vehicle, and identified by reference numeral 1. The front headlamp comprises an outer lens 2, which is a multicomponent injection molding, as described in detail further down. A majority of the outer lens is transparent, in order to allow light to exit from the lighting device. Within the lighting device there are a plurality of lighting units or lighting modules, which are shown merely schematically in FIG. 1 by illustration of their outlines.

In the right-hand region of the outer lens 2 is a main light module 3, which is intended to create the dip beam and the high beam of the motor vehicle and is a first lighting unit in the context of the claims. The main light module contains two optical units 3b and 3c that are indicated merely schematically, with which dip beam and high beam are generated by way of light from light sources behind the optical units (not shown).

Above the main light module 3, behind the outer lens 2, are disposed two signal lighting units or signal lighting modules 4, 4′, which are second lighting units in the context of the claims. The signal lighting units are shown merely schematically in FIG. 1 as bars and serve collectively to create daytime running light while running in daylight, and to create position light while running in darkness. When generating daytime running light and position light, the signal lighting units emit white light. In addition, the signal lighting unit 4 also assumes the function of the turn signal. This means that the activation of the turn signal actuates flashing of the signal lighting unit 4 in a yellow color, such that, during the flashing, the function of the daytime running light or position light of this signal unit is deactivated. After the flashing has ended, the signal lighting unit shines again in the white color of the daytime running light or position light. In the region of the outer lens 2, behind which there are the main light module 3 and the signal lighting units 4, 4′, the outer lens is completely transparent, in order thereby to assure the creation of the dip beam or high beam and of the signal lighting functions efficiently with low energy losses.

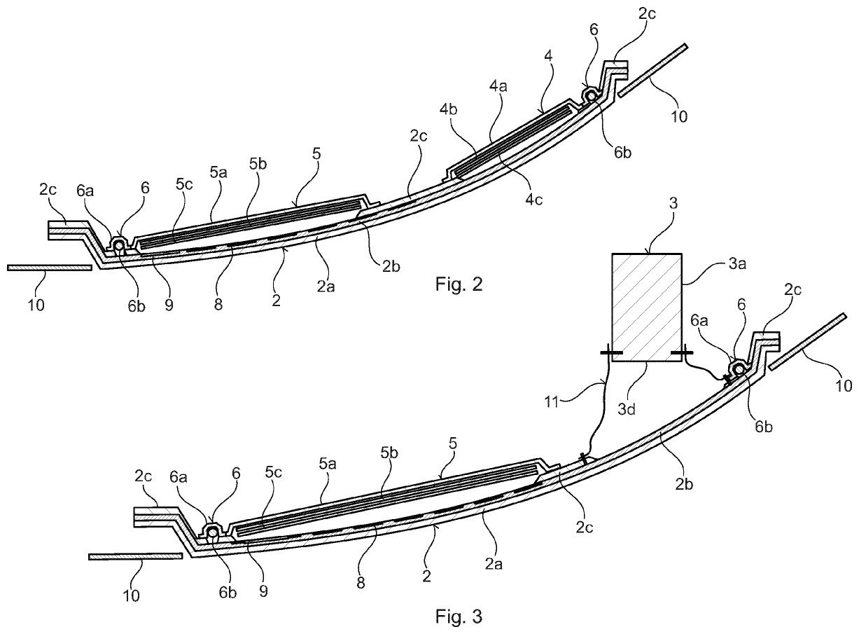

To the left alongside the main light module 3 and the signal lighting units 4, 4′ is an area lighting device 5, of which merely the outline is indicated by a dotted line, and which constitutes a (further) second lighting unit in the context of the claims. The area lighting device 5 is disposed behind a stripe pattern 8 (see FIG. 2 to FIG. 4) of the outer lens 2 and, on activation, creates an area of light within its outline, such that stripes of light become visible on the outer lens because of the stripe pattern 8. There may optionally also be a different pattern than a stripe pattern or else no pattern at all on the outer lens in the region of the area lighting device 5.

The area lighting device 5 is preferably used for light effects. The area lighting device 5 can be actuated here such that it is also possible to illuminate only subareas within its outline and hence to generate dynamic light movements. This can be utilized, for example, in the case of a welcome scenario for the driver when unlocking the motor vehicle. In the case of this welcome scenario, a pleasing dynamic light image is generated by way of the area lighting device 5 in both front headlamps, optionally in conjunction with the position light, and the driver is greeted thereby.

In addition, the front headlamp 1 comprises what is called a contour lighting device 6, which is shown merely schematically by a dotted line running around the edge of the outer lens. The contour lighting is implemented by a circumferential light guide, as described in detail further down. The activation of the contour lighting achieves a pleasing appearance of the front of the motor vehicle.

The front headlamp 1 further comprises a radar 7 disposed on the left-hand side of the outer lens 2 beneath and alongside the area lighting device 5. Only the outline of the radar is indicated in FIG. 1. The radar emits radar beams and detects the radar echoes received, in order thereby to measure distances from objects. The radar is used in driver assistance functions, for example a pedestrian warning or active cruise control. The stripe pattern 8 in front of the area lighting device 5 also runs across the radar 7. However, the stripe pattern is transparent to the wavelength of the radar radiation, and so the intensity of the radar radiation emitted is not impaired by the stripe pattern.

FIG. 1 also indicates three dashed-and-dotted lines L1, L2 and L3, which indicate section lines, with the corresponding sections along these lines shown in FIG. 2 to FIG. 5. The sections are along the corresponding line in horizontal direction, and FIG. 2 to FIG. 5 show the viewing direction of the respective sections in vertical direction from the top downward.

In the embodiment of the front headlamp 1 shown here, the inner surface of the headlamp, which is visible through the outer lens 2, has a light-absorbing or dark configuration. In this way, a viewer perceives an essentially dark area in the region of the outer lens in the cold appearance of the headlamp (i.e. with the headlamp switched off). In addition, the outer lens 2 extends from the left-hand edge or fender of the motor vehicle almost up to the center thereof in its transverse direction. In this way, the headlamps installed on the two sides achieve a pleasing appearance of a continuous area on the front of the motor vehicle. This dispenses with the integration of a kidney on the front of the motor vehicle.

Furthermore, the outer lens 2 concludes flush with the bumper fascia 10 (see FIG. 2 to FIG. 4) on the front of the motor vehicle, which achieves a visually pleasing design. However, there is the problem that a low-speed impact on the front of the motor vehicle (as, for example, in the case of a minor parking accident) will result in a direct force acting on the outer lens 2, since there is no curved bumper region below the front headlamp. This force may lead to displacement or damage to the lighting units installed in the front headlamp. In order to avoid this problem, the lighting units are arranged behind the outer lens in a specific manner, as elucidated in detail hereinafter with reference to FIG. 2 to FIG. 5.

FIG. 2 shows a section along line L1 in FIG. 1, meaning that the section runs through the contour lighting device 6, the area lighting device 5 and the upper signal lighting unit 4. The outer lens 2 is a component which is composed of multiple plastic components and has been manufactured by multicomponent injection molding and comprises an outer transparent component or layer 2a, a transparent film 2b applied atop layer 2a, and a further component in the form of an opaque layer 2c that has been provided solely in subareas atop film 2b and serves to secure the signal lighting units 4, 4′, the area lighting device 5, the contour lighting device 6 and the radar 7. It is also apparent from FIG. 2 that the outer lens 2 concludes flush with the bumper fascia, identified by reference numeral 10.

In the region of the outer lens through which the area lighting device 5 emits light, the stripe pattern 8 already mentioned above has been printed onto the film 2b, and also printed on in this region is a decoration 9 that becomes visible when the area lighting device 5 is switched on. In the embodiment described here, the decoration is the emblem or logo of the vehicle manufacturer. By contrast with the area lighting device 5, there is neither a stripe pattern nor a decoration in the regions of the outer lens behind which the main light module 3, the signal lighting units 4, 4′ and the contour lighting device 6 are present.

According to FIG. 2, the signal lighting unit 4 comprises a housing 4a which is open toward the outer lens 2, in which there is a light emitter in the form of a printed circuit board 4b equipped with LEDs and diffusing optics 4c in front of the latter. The LEDs may give off different colors, such that both an indicating function (lit in yellow color) and a daytime running light function or position light function (lit in white color) are achieved. The signal lighting unit 4 and also the signal lighting unit 4′ which is apparent from FIG. 1, and which is of identical construction to the signal lighting unit 4, are rigidly connected to the outer lens 2 via the housing 4a, with the housing 4a bonded to the layer 2c in the working example described here.

The area lighting device 5 is of similar construction to the signal lighting unit 4. This means that it comprises a housing 5a which is open toward the outer lens 2 and comprises a light emitter in the form of a printed circuit board 5b equipped with LEDs and diffusing optics 5c in front of the latter. This area lighting device 5 is likewise rigidly connected to the outer lens 2 in that the housing 5a is stuck to the layer 2c of the outer lens 2.

Also apparent from FIG. 2 are the sections through the circumferential contour lighting device 6. The contour lighting device 6 comprises a housing 6a which is open with respect to the outer lens and runs around the edge of the outer lens, in which there is a light guide 6b. The light guide is fed with light via a light source at one end (not apparent from the figures). This light is outcoupled therefrom via an outcoupling structure on the side of the light guide 6b adjacent to the housing 6a, which gives rise to circumferential contour light. The inside of the housing 6a has a reflective configuration, which increases the brightness of the contour lighting. In analogy to the signal lighting units 4, 4′ and the area lighting device 5, the contour lighting device 6 is also rigidly connected to the outer lens 2 in that the housing 6a is stuck to the layer 2c of the outer lens. The rigid securing of the lighting units 4, 4′, 5 and 6 to the outer lens 2 firstly achieves a compact construction of the headlamp and secondly prevents damage to these lighting units via a force acting on the outer lens, since the lighting units move together with the outer lens.

FIG. 3 shows a section along line L2 in FIG. 1. This line runs through the contour lighting device 6, the area lighting device 5 and the main light module 3, except that the interior of the main light module is not shown in section. As can be seen, the main light module 3 comprises a housing 3a with an open front side or light exit opening 3d, via which the light generated in the main light module exits via the optical units 3b and 3c. Because of the size and depth of the main light module 3, it is impracticable to rigidly connect this module to the outer lens 2. Furthermore, the main light module contains an illumination width regulator for adjusting the dipped beam to the loading of the motor vehicle, and so, for that reason too, rigid securing of the main light module to the outer lens is impossible.

In order nevertheless to prevent movement of or damage to the main light module 3 as a result of the movement of the outer lens 2 in the event of an impact, the main light module 3 is positioned at a distance from the outer lens 2. In order to prevent the penetration of soil or other particles into the interior of the housing 3a via the light exit opening 3d, a shell or sealing sleeve 11 is provided between the main light module 3 and outer lens 2. The end of the sealing sleeve adjacent to the housing 3a of the main light module 3 runs around the circumference of the light exit opening 3d and is secured with sealing to the housing, as described further down with reference to FIG. 5. The end of the sealing sleeve adjacent to the outer lens 2 is likewise mounted with sealing on layer 2c of the outer lens, as likewise still to be described in detail with reference to FIG. 5.

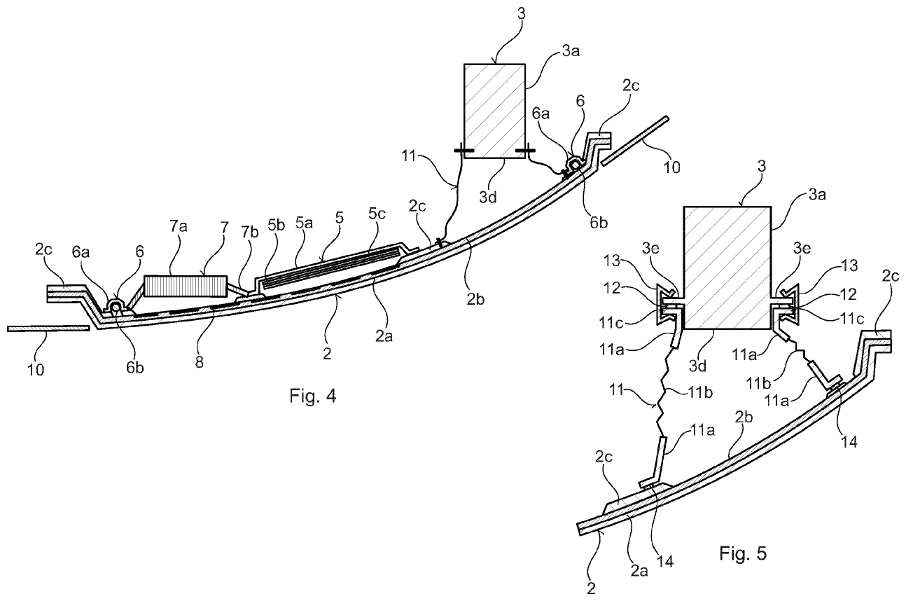

FIG. 4 shows a section along line L3 in FIG. 1, where this line runs through the contour lighting device 6, the radar 7, the area lighting device 5 and the main light module 3. As can be seen from FIG. 4, the radar 7 comprises an emitting and receiving unit 7a for emitting radar rays and receiving the corresponding radar echoes. In analogy with the lighting units 4, 4′, 5 and 6, the radar 7 is also rigidly connected to the outer lens 2. For this purpose, a funnel-shaped holder 7b mounted on the emitting and receiving unit 7a is stuck to layer 2c of the outer lens. This rigid securing counteracts damage to the radar resulting from movement of the outer lens 2 in the event of an impact, since the radar moves with the outer lens.

FIG. 5 shows a detail view of the main light module 3 from FIG. 5 and the securing thereof on the outer lens 2, with omission of the contour lighting device 6 for reasons of clarity. As can be seen, the sealing sleeve 11 that connects the main light module 3 to the opaque layer 2c of the outer lens 2 consists of a plastic composed of two different components. The edges 11a of the sealing sleeve 11 consist of a mixture of polycarbonate and ABS plastic (ABS=acrylonitrile-butadiene-styrene). By contrast, the middle section 11b of the sealing sleeve is formed from TPE plastic (TPE=thermoplastic elastomer). The TPE plastic ensures the flexibility of the sealing sleeve 11. The edge of the sealing sleeve 11 adjacent to the outer lens 2 is bonded by way of polyurethane adhesive 14 to layer 2c of the outer lens. By contrast, the opposite edge of the sealing sleeve 11 is mounted on the main light module 3 by way of a total of eight metal clips 13, with two of these clips apparent in FIG. 5. The main light module comprises a circumferential projection 3e which presses against a projection 11c of the sealing sleeve via a sealing element 12 made of EPDM material (EPDM=ethylene-propylene-diene rubber). The compression force is generated by way of the metal clips 13. Such a construction gives very good protection of the components of the main light module 3 that are exposed via the light exit opening 3d against the penetration of dust or other particles.

Rather than a sealing sleeve, it is also possible to use a different form of sealing. It is likewise possible for the sealing sleeve to consist of other materials or to be secured to the main light module or outer lens in another way. For example, rather than securing by way of clips, it is also possible to utilize securing by way of adhesive bonding, clamping and the like.

The above-described embodiment of the invention has a number of advantages. In particular, a motor vehicle lighting device is provided in the form of a front headlamp, the components of which are well protected against damage in the event of a low-speed impact. This is brought about firstly by the spacing of the main light module from the outer lens and secondly by a rigid mechanical connection of further lighting units to the outer lens. In this way, movements or shifts of the outer lens in the event of a low-force impact are prevented from leading immediately to damage to the lighting units installed in the front headlamp. Furthermore, the positioning of lighting units directly on the outer lens ensures a compact construction of the lighting device. Nevertheless, it is also possible that one or more of the lighting units connected rigidly to the outer lens in the embodiment described above are spaced apart therefrom.

### LIST OF REFERENCE NUMERALS

1 front headlamp (lighting device)
2 outer lens
2a transparent component
2b film (for decoration and/or opacity)
2c opaque component
3 first lighting unit (main light module)
3a housing of the main light module
3b, 3c optical units
3d light exit opening in the main light module
3e projection in the main light module
4, 4′ signal lighting units (two lighting units)
4a housing of the signal lighting unit
4b printed circuit board with direct-emitting LEDs
4c diffusing optics
5 area lighting device (second lighting unit)
5a housing of the area lighting device
5b printed circuit board with direct-emitting LEDs
5c diffusing optics
6 contour lighting device
6a housing of the contour lighting device
6b light guide of the contour lighting device
7 radar (emission unit)
7a transmitting and receiving unit
7b holder
8 stripe pattern
9 decorative print
10 bumper fascia
11 sealing sleeve (flexible connector)
11a, 11b material components of the sealing sleeve
11c projection on the sealing sleeve
12 sealing element
13 metal clips
14 adhesive

1.-15. (canceled)

16. A lighting device for a motor vehicle, the lighting device comprising:
one or more first lighting units, each of which is configured to generate a distribution of light for a dip beam function and/or a high beam function, and
one or more second lighting units, each of which is configured to create a light distribution for a light function other than the dip beam function and the high beam function, wherein:
the one or more first lighting units and the one or more second lighting units are covered by a common outer lens which is transparent at least in sections and through which light coming from the one or more first lighting units and the one or more second lighting units exits from the lighting device,
each of the one or more first lighting units is spaced apart from the outer lens, and
each of the one or more second lighting units is rigidly connected to the outer lens or spaced apart from the outer lens.

17. The lighting device according to claim 16, wherein the one or more second lighting units are configured to create a light distribution for a daytime running light, for a position light, for a turn signal, for illumination of an area along the outer lens, and/or for contour lighting along one edge of the outer lens.

18. The lighting device according to claim 16, wherein at least one of the one or more first lighting units is a lighting module comprising a first housing in which there is disposed a light emitter for creating the distribution of light for the dip beam function and/or the high beam function.

19. The lighting device according to claim 18, wherein the first housing is connected to the outer lens via a flexible connector.

20. The lighting device according to claim 19, wherein the flexible connector is a sleeve having two opposite open ends, where a first one of the ends is secured to the first housing and a second one of the ends is secured to the outer lens.

21. The lighting device according to claim 20, wherein the first one of the ends is secured to the housing around a light exit opening.

22. The lighting device according to claim 20, wherein the sleeve is formed from material impervious to dust and is secured with sealing by the ends to the first housing and to the outer lens.

23. The lighting device according to claim 16, wherein at least one of the one or more second lighting units is a lighting module comprising a second housing in which there is disposed a light emitter for creating the light distribution for the light function other than the dip beam function and the high beam function.

24. The lighting device according to claim 23, wherein the second housing is rigidly connected to the outer lens.

25. The lighting device according to claim 16, wherein at least one of the one or more second lighting units comprises a surface light guide.

26. The lighting device according to claim 16, further comprising one or more radiation units for emission of radiation other than light.

27. The lighting device according to claim 26, wherein at least one of the one or more radiation units is rigidly connected to the outer lens.

28. The lighting device according to claim 16, wherein the outer lens is formed from plastic.

29. The lighting device according to claim 28, wherein the outer lens is a multicomponent injection molding.

30. The lighting device according to claim 16, wherein an inner surface of the lighting device which is visible through the outer lens has an absorptivity of 50% or more for light.

31. The lighting device according to claim 16, wherein an inner surface of the lighting device which is visible through the outer lens has an absorptivity of 90% or more for light.

32. The lighting device according to claim 16, wherein the outer lens, upon installation in the motor vehicle, has an extent in a transverse direction of the motor vehicle that extends from one edge of the motor vehicle to essentially a center of the motor vehicle.

33. A motor vehicle comprising the lighting device according to claim 16.
